(19) United States
(12) Patent Application Publication
(10) Pub. No.: US 2008/0204590 A1
(43) Pub. Date: Aug. 28, 2008

(54) Lens drive apparatus, image pickup apparatus and mobile terminal

(75) Inventors: Kazumi TOYA, Tokyo (JP); Kenichi KUBO, Tokyo (JP); Hikaru NAGASAWA, Tokyo (JP)

Correspondence Address: COHEN, PONTANI, LIEBERMAN & PAVANE LLP, 551 FIFTH AVENUE, SUITE 1210, NEW YORK, NY, 10176, US

(73) Assignee: Konica Minolta Opto, Inc., Tokyo (JP)

(21) Appl. No.: 11/977,658

(22) Filed: Oct. 24, 2007

(30) Foreign Application Priority Data
Feb. 22, 2007 (JP) 2007-041949

(51) Int. Cl. H04N 5/225

(52) U.S. Cl. 348/373; 348/E05.024

(57) ABSTRACT

The present invention provides a lens drive apparatus including: an image pickup lens group; a lens frame holding the image pickup lens group; an actuator comprising a magnet, a yoke, and a coil formed of an electric conductor; a casing housing the lense frame and the actuator therein; and at least one guide shaft parallel to an optical axis of the image pickup lens group. An electromagnetic force generated when electricity is applied to the coil, moves the lens frame and the image pickup lens along the optical axis.

This application is based on Japanese Patent Application No. 2007-041949 filed on Feb. 22, 2007, in Japanese Patent Office, the entire content of which is hereby incorporated by reference.

### FIELD

The present invention relates to a lens drive apparatus which is suitable for a compact size image pickup apparatus installed to a mobile terminal such as a cellular phone, and to an image pickup apparatus and a mobile terminal.

### BACKGROUND

In recent year, a compact and thin type image pickup apparatus has been installed to a compact and thin type mobile terminal, such as a cellular phone and a PDA (Personal Digital Assistant). Based on this technology, it has come to the situation where not only audible information but also image information can be transmitted to a remote place. Solid-state image pickup elements, such as, a CCD (Charge Coupled Device) type image sensor and a CMOS (Complementary Metal-Oxide Semiconductor) type image sensor are used for the image pickup element of the image pickup apparatus.

Further, with respect to the image pickup apparatus which is utilized for a cellular phone and a PDA, there has been proposed various kinds of image pickup apparatuses employing not only a fixed focus system but also a system which moves an image pickup lens group in an optical axis direction in response to the distance to an object to obtain a sharp image.

As a drive apparatus for moving the image pickup lens group in the optical axis direction described above, for example, Unexamined Japanese Patent Application Publication (JP-A) No. 2005-128392 discloses a lens drive apparatus including a coil, a magnet, and yoke, for moving a lens frame and an image pickup lens group by an electromagnetic force which is generated by the electricity applied to the coil.

FIG. 7 illustrates a schematic cross sectional view showing an area surrounding a yoke, a magnet, and a coil of a lens drive apparatus in a prior art. As illustrated in FIG. 7, an image pickup lens group 10 having an optical axis “O” is disposed in front of an image pickup element 51. A coil 33 is fixed and adhered onto a lens frame 22 holding this image pickup lens group 10. A magnet 32, which has been magnetized in one magnetic pole, is fixed and adhered onto a U-shaped yoke 31 which is a magnetic material. The coil 33, as illustrated in FIG. 7, is disposed between the yoke 31 and the magnet 32, and a closed magnetic circuit is formed by the yoke 31.

The lens frame 22 is held by being bound between plate springs 23 and 24. When electricity is applied to the coil 33, the magnetic field of the magnet 32 and the electric current which flows in the coil 33 generate an electromagnetic force. This electromagnetic force moves the lens frame 22 and the coil 33 in the optical axis “O” direction (in an arrow direction as illustrated in FIG. 7) against the pressing force of the plate springs 23 and 24. A focusing operation is performed based on this operation described above.

The lens drive apparatus which is disclosed by JP-A No. 2005-128392, holds a lens frame holding the lens group by binding the lens frame by two plate springs, and moves the lens frame and the image pickup lens group against the pressing force of the two plate springs by electromagnetic force.

In this structure, unless two plate springs are disposed to be in parallel precisely and the lens drive apparatus is assembled so that the pressing force direction is in correctly parallel with the optical axis, the lens frame or the image pickup lens group becomes in a shifted or tilted condition when the lens frame moves in the optical axis. Thus, such a structure requires a highly precise assembly. Accordingly, there has been a problem that the performance in assembly deteriorated and the productivity was low. Further, since the lens frame is hold only by being bound by the two plate springs, there is an influence of a difference in physical orientation due to the self weight of the lens frame and the image pickup lens group.

### SUMMARY

To solve the problems described above, an object of the present invention is to provide a lens drive apparatus without an influence of a difference in the physical orientation, preventing the image pickup lens group moving in the optical axis direction from shifting and tilting, and providing the enhanced performance of assembly for manufacturing, and to an image pickup apparatus and a mobile terminal.

The present invention provides a lens drive apparatus including: an image pickup lens group; a lens frame holding the image pickup lens group; an actuator including a magnet, a yoke, and a coil formed of an electric conductor; a casing housing the lens frame and the actuator therein; and at least one guide shaft parallel to an optical axis of the image pickup lens group. An electromagnetic force generated when electricity is applied to the coil, moves the lens frame and the image pickup lens along the optical axis. Herein, the guide shaft is fitted with the casing, or is formed on the lens frame and fitted with the casing.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 illustrates a schematic diagram of a cellular phone, which is an example of the mobile terminal including an image pickup apparatus having a lens drive apparatus relating to the present invention;

FIG. 2 illustrates a control block diagram of the cellular phone;

FIG. 3 illustrates a perspective view of an image pickup apparatus of an embodiment of the present invention;

FIG. 4 illustrates a cross sectional view of the image pickup apparatus of the embodiment of the present invention;

FIG. 5 illustrates an exploded perspective view of a lens frame around which a coil is wound, a guide shaft and a plate spring;

FIG. 6 illustrates a cross sectional view for showing and other example of the image pickup apparatus of the present invention;

FIG. 7 illustrates a schematic diagram of a cross section showing an are surrounding a yoke, a magnet and a coil of the lens drive apparatus in a prior art; and

FIG. 8 illustrates other example of the image pickup apparatus of the embodiment of the present invention.

### DESCRIPTION OF THE PREFERRED EMBODIMENT

The preferred embodiments of the present invention will be described below.

A preferred embodiment of the present invention is a lens drive apparatus comprising: an image pickup lens group; a lens frame holding the image pickup lens group; an actuator comprising a magnet, a yoke, and a coil formed of an electric conductor; a casing housing the lens frame and the actuator therein; and at least one guide shaft parallel to an optical axis of the image pickup lens group. The guide shaft is fitted with the casing. In the lens drive apparatus, an electromagnetic force generated when electricity is applied to the coil, moves the lens frame and the image pickup lens along the optical axis.

The above lens drive apparatus can comprises one or two guide shaft.

The above lens drive apparatus may further comprise: a pressing member for pressing the lens frame in a predetermined direction, and a part of the pressing member may be engaged with or fixed to the lens frame. Further, the pressing member can be a plate spring.

In the above lens drive apparatus, the guide shaft may be formed of a metal material. Further, in the lens drive apparatus, the guide shaft and the casing may be integrally formed in one body.

In the above drive apparatus, the coil, the magnet, and the yoke may be arranged on a side surface of the lens frame.

Another preferred embodiment is an lens drive apparatus comprising: an image pickup lens group; a lens frame holding the image pickup lens group; an actuator comprising a magnet, a yoke, and a coil formed of an electric conductor; a casing housing the lens frame and the actuator therein; and at least one guide shaft parallel to an optical axis of the image pickup lens group. The guide shaft is formed on the lens frame and fitted with the casing. In the lens drive apparatus, an electromagnetic force generated when electricity is applied to the coil, moves the lens frame and the image pickup lens along the optical axis.

The above lens drive apparatus can comprise one or two guide shafts. Further, in the above lens drive apparatus, the guide shaft may comprise two ends arranged along different lines parallel to the optical axis and each fitted with the casing.

The above lens drive apparatus, may further comprise: a pressing member for pressing the lens frame in a predetermined direction and a part of the pressing member may be engaged with or fixed to the lens frame. Herein, the pressing member can be a plate spring.

In the above lens drive apparatus, the coil, the magnet, and the yoke may be arranged on a side surface of the lens frame.

Another preferred embodiment is an image pickup apparatus comprising any one of the above the lens: drive apparatuses.

Another preferred embodiment is a mobile terminal comprising the above image pickup apparatus.

According to the embodiments of the present invention, it becomes possible to provide a lens drive apparatus without the influence of the difference in the physical orientation, preventing the image pickup lens group moving in the optical axis direction from shifting and tilting, and providing the enhanced performance of assembly for manufacturing, and to an image pickup apparatus and a mobile terminal.

The present invention will be described by using embodiments in detail, with referring the drawings. However, the present invention is not limited to these embodiments.

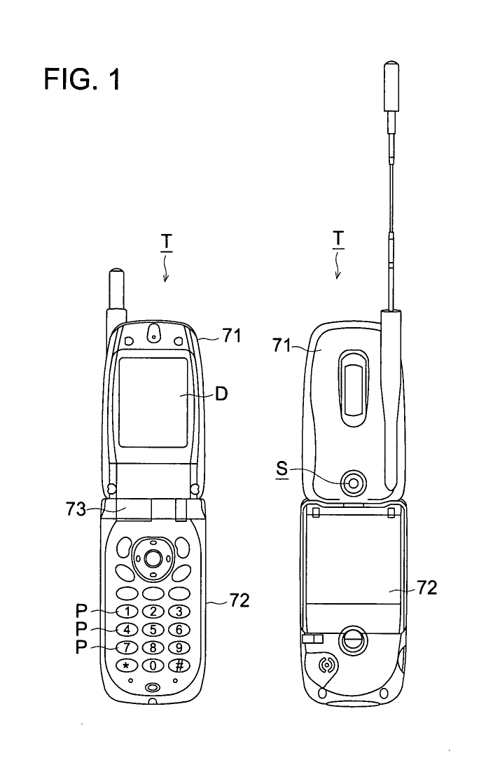

FIG. 1 illustrates a schematic diagram of a cellular phone “T”, which is an example of the mobile terminal including an image pickup apparatus “S” having a lens drive apparatus relating to the present invention.

In a cellular phone “T” illustrated in FIG. 1, an upper casing 71 as a case having a display screen “D” is connected to a lower casing 72 including operation buttons, by a hinge 73. In image pickup apparatus S is installed in a lower direction of the display screen “D” in the upper casing 71 so that the image pickup apparatus “S” is able to take light in from the outer surface side of the upper casing 71.

The position of the image pickup apparatus “S” may be disposed in the upper casing 71. It is also apparent that the cellular phone “T” is not limited to the folding type cellular phone.

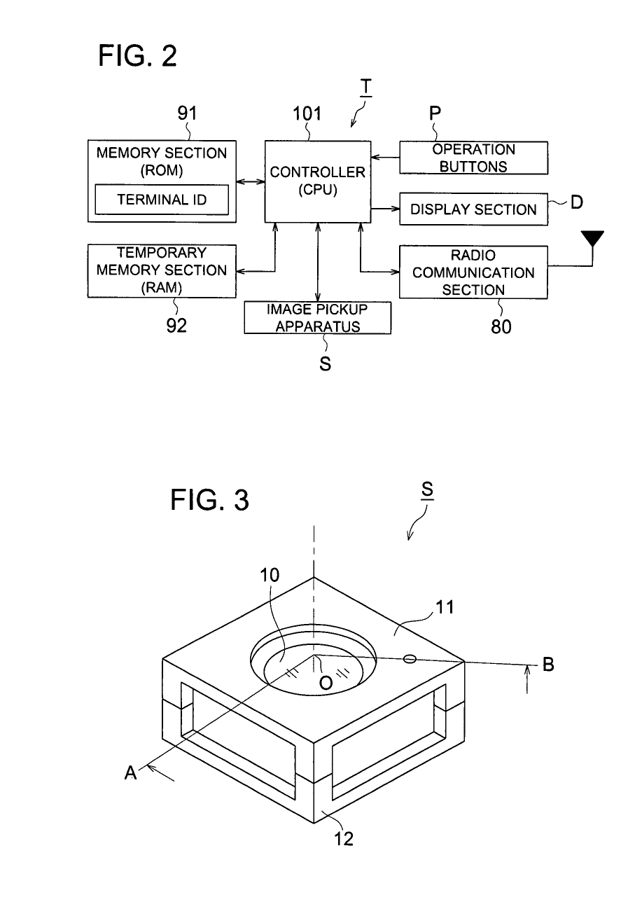

FIG. 2 illustrates a control block diagram of the cellular phone “T”.

As illustrated in FIG. 2, the image pickup apparatus “S” is connected to a controller 101 of the cellular phone “T” and outputs image signals, such as, brightness signal and color difference signal to the controller 101.

On the other hand, the cellular phone “T” includes the controller (CPU) 101 for totally controlling respective sections and at the same time, executing programs corresponding to respective processes, a display section “D” for displaying predetermined data and photographed images, a radio communication section 80 for establishing various types of information communication between the cellular phone and external servers, a memory section (ROM) 91 which memorizes a system program of the cellular phone, various process programs and various necessary data, such as a terminal ID and a temporary memory section (RAM) 92 for temporally storing various programs and data, which is executed by the controller 101, or temporally storing process data and image data from the image pickup apparatus “S”.

The image signal which has been inputted from the image pickup apparatus “S”, is memorized to the memory section 91, or displayed onto the display screen “D”, further transmitted outside via the radio communication section 80 by the controller 101 of the cellular phone “T”.

An embodiment of the lens drive apparatus installed in an image pickup apparatus “S”, which is installed in the mobile terminal described above will be described.

FIG. 3 illustrates a perspective view of an image pickup apparatus “S” of an embodiment of the present invention.

As illustrated in FIG. 3, the image pickup apparatus “S” has been structured into a substantially rectangular solid, which is a parallelepiped shape. The image pickup apparatus “S” is formed by an upper casing 11 and a lower side casing 12. In the upper casing 11, as illustrated in FIG. 3, an opening is formed, and an image pickup lens group 10 is disposed so as to be able to take object light through the opening in the upper casing 11. Further, an opening (not shown) also is formed in the lower casing 12, and the image pickup element (not shown) is provided in the opening in the lower casing 12.

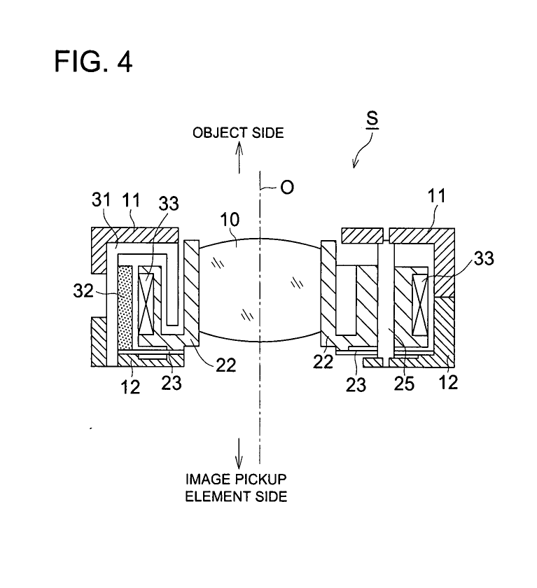

FIG. 4 illustrates a cross sectional view of the image pickup apparatus “S” of the embodiment of the present invention. The cross sectional view illustrated in FIG. 4 shows a cross sectional view, which is viewed by cutting at an A-O line and an O-B line illustrated in FIG. 3. The left side of the optical axis in FIG. 4 corresponds to an O-A cross sectional view. The right side of the optical axis is FIG. 4 corresponds to an O-B cross sectional view. In FIG. 4, the image pickup apparatus is omitted.

As illustrated in FIG. 4, the upper casing 11 and lower casing 12 houses image pickup lens group 10 and an actuator including a magnet 32, yoke 32, and a coil formed by an electric conductor.

As illustrated in the left side of the optical axis (the A-O cross section) of FIG. 4, the coil 33 is wound around the outer circumference of the lens frame 22 which holds image pickup lens group 10. The magnet 32 is disposed so as to oppose to this coil 33. The U-shaped yoke 31 holds the magnet 33. The disposition of the coil 33, the magnet 32 and yoke 31 is not limited to this embodiment. For example, they may be disposed in the order of an inner yoke, the magnet and an outer yoke from the lens frame toward the outside. The coil may be disposed between the inner yoke and the outer yoke and may be shifted from the magnet in the optical axis direction.

As illustrated in the right side of the optical axis (the O-B cross section) in FIG. 4, the image pickup apparatus “S” is assembled so that the guide shaft 25 which is parallel with the optical axis, fits to the holes formed in the lens frame 22. The lens frame 22 is designed to be capable of moving in the optical axis direction by being guided by the guide shaft 25. Further, as illustrated in FIG. 4, the plate spring 23, which is a pressing member, may be disposed in the image pickup element side of the lens frame 22.

This guide shaft 25 may be formed by a metal material. It becomes possible to suppress the dispersion of the diameter dimension of the guide shaft and allows the lens frame to further smoothly slide by forming the guide shaft using a metal material. This guide shaft 25 may be a shaft which is formed together with the upper casing 11 or the lower casing 12. By forming the shaft member as one body, since the number of parts can be reduced.

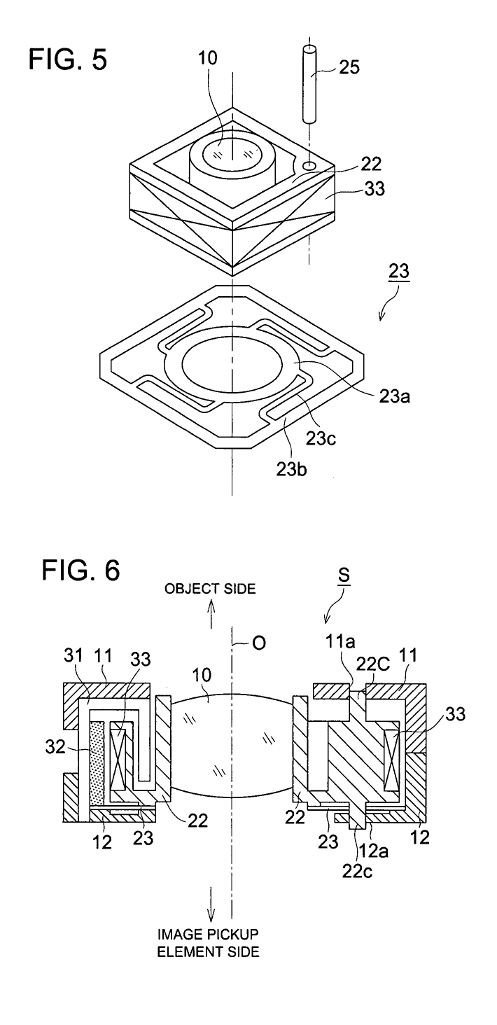

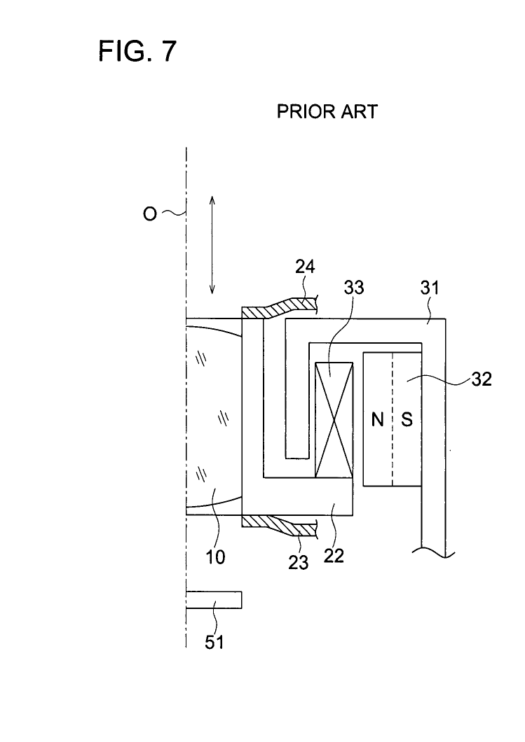

FIG. 5 illustrates an exploded perspective view of a lens frame 22 around which a coil 55 is wound, a guide shaft 25 and a plate spring 23.

As illustrated is FIG. 5, the plate spring 23 is formed by, for example, an inner side section 23a which has been formed in a circular ring shape, an outer side section 23b which has been formed in a substantially rectangular shape, and an arm section 23c for connecting the inner side section and the outer side section. The inner side section 23a of the plate spring 23 is fixed onto the lens frame 22, and the outer side section 23b is fixed onto the lower casing 12.

Returning to FIG. 4, the lens frame 22 is pressed to the image pickup element side by the arm section 23c of the plate spring 23. When electricity is not applied to the coil, the lens frame 22 is in the state where the lens frame 22 touches to the lower casing 12 and stops based on this pressing force. The image pickup lens group 10 under the condition is preferably set so that the focal distance of the pickup lens is set to infinity or a hyper focal distance.

When electricity is applied to the coil 33, since the lens frame 22 fits into the guide shaft 25, the lens frame 22 can be moved to the object side in the optical axis direction without tilted. In case when the plate spring is disposed, since the inner side section 23a of the plate spring 23 fixes to the lens frame 22, the lens frame 22 can be moved toward the object side in the optical axis direction without shifted into the direction perpendicular to the optical axis.

FIG. 6 illustrates a cross sectional view for showing and another example of the image pickup apparatus “S” relating to the present invention. In FIG. 6, in order not to duplicate the explanation, the same symbol is given to the same functional member as the image pickup apparatus S, which is illustrated in FIG. 4 and only different portions will be described.

In the image pickup apparatus S illustrated in FIG. 6, a guide shaft 22c is integrally formed with the lens frame 22 in the object side and the image pickup element side. The edge sections in the object side and the image pickup element side of the guide shaft fit to holes 11a and 12a respectively formed on the upper casing 11 and the lower casing 12. The other portions are the same as the one illustrated in FIG. 4.

In the case that the guide shaft is integrally formed with the lens frame 22, the both end sections of the guide shaft in the object side and the image pickup element side should be respectively parallel to the optical axis. The end sections may be respectively disposed on the different straight lines parallel to the optical axis, to fit with the casing. Namely, as long as the both end sections are parallel to the optical axis, the both end sections may be formed so that the position of the both end sections are shifted to each other. Alternatively, the guide shaft may be integrally formed with the lens frame 22 in either the object side or the image pickup side, and the corresponding casing may include a receiving section in a cylinder shape, which fits with guide shaft.

As described above, the lens drive apparatus relating to the present invention has a structure in which the lens frame 22 fits to the guide shaft 25 or the guide shaft 22c fits to the holes 11a and 12a formed in the casing so as to guide the lens frame 22 in the optical axis direction. Thereby, the lens drive apparatus relating to the present invention can solve the problem associated with tilt of the lens frame 22 or an image pickup lens group 10, which is caused when moving the lens frame 22 in an optical axis direction. Further, by fitting the lens frame 22 to the guide shaft 25, or by fitting the guide shaft 22c to the holes 11a and 12a formed in the body, the influence of the difference in the physical orientation due to the self-weight can be solved. Further, in case when the plate spring 23 which is a pressing force member, is used in the lens drive apparatus of the embodiment, the plate spring 23 can have two roles for preventing the lens frame from rotating and for giving pressing force in the optical direction to the lens frame 22. Thereby, the plate spring can dissolve the shift of the lens frame 22 or the image pickup lens group 10, which is caused when moving the lens frame 22 or the image pickup lens group 10 in the optical direction. In this case, only one plate spring 23 may be enough. It makes the assembly easy and improves the performance of the assembly.

Here, with respect to the plate spring 23 in the explanation above, an example that the plate spring 23 is disposed in the image pickup side, has been explained. However, the plate spring 23 may be disposed in the object side of the lens frame 22. In this case, when the plate spring 22 is assembled so that the pressing force is given in the image pickup direction, it is not necessary to fix the inner side section of the plate spring to the lens frame 22. It will be acceptable if an engaging section for preventing rotation of the lens frame 22 is provided.

Further, even in case when an embodiment of the present invention utilizes two plate springs, the lens frame is guided in the optical axis direction by the guide shaft. Therefore, a subtle assembly work needed in a conventional art is not required and the performance of assembly can be improved.

Further, in addition to the structure described above, by disposing a coil, a magnet and a yoke on the side surface of the lens frame, the thickness of the image pickup apparatus in the optical axis direction can be suppressed and particularly a thin image pickup apparatus in the optical direction can be obtained.

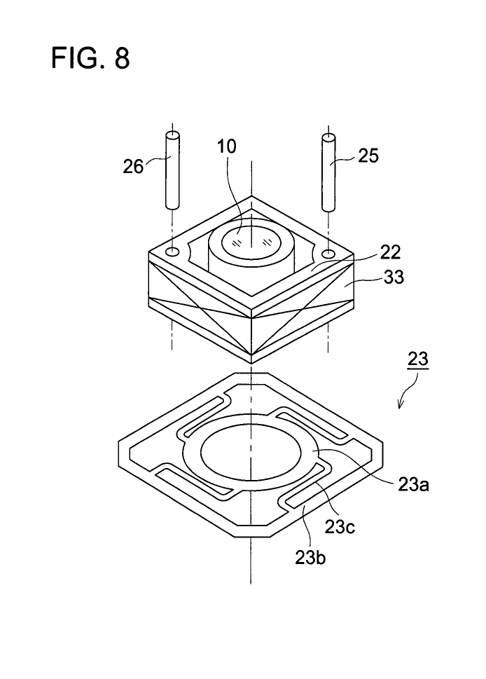

In the description above, the embodiments employing one guide shaft have been described by using FIGS. 4 and 6. However, as illustrated in FIG. 8, the image pickup apparatus may be structured so that there are provided two guide shafts and that the lens frame 22 is guided by two guide shafts 25 and 26 in the optical axis direction. According to this structure, the rotation of the lens frame 22 centering on either guide shaft can be suppressed and the shift of the image pickup lens can be resolved more effectively. In case when the structure employs the plate spring, it is not necessary to fix or engage the plate spring to the lens frame as long as the plate spring is arranged to give the pressing force to the lens frame in a predetermined direction.

While the preferred embodiments of the present invention have been described using specific terms, such description is for illustrative purposes only, and it is to be understood that changes and variations may be made without departing from the spirit or scope of the appended claims.

What is claimed is:

1. A lens drive apparatus comprising:
an image pickup lens group;
a lens frame holding the image pickup lens group;
an actuator comprising a magnet, a yoke, and a coil formed of an electric conductor;
a casing housing the lens frame and the actuator therein; and
at least one guide shaft parallel to an optical axis of the image pickup lens group, the guide shaft being fitted with the casing,
wherein an electromagnetic force generated when electricity is applied to the coil, moves the lens frame and the image pickup lens along the optical axis.

2. The lens drive apparatus of claim 1, comprising one guide shaft.

3. The lens drive apparatus of claim 1, comprising two guide shafts.

4. The lens drive apparatus of claim 1, further comprising:
a pressing member for pressing the lens frame in a predetermined direction,
wherein a part of the pressing member is engaged with or fixed to the lens frame.

5. The lens drive apparatus of claim 4,
wherein the pressing member is a plate spring.

6. The lens drive apparatus of claim 1,
wherein the guide shaft is formed of a metal material.

7. The lens drive apparatus of claim 1,
wherein the guide shaft and the casing are integrally formed in one body.

8. The lens drive apparatus of claim 1,
wherein the coil, the magnet, and the yoke are arranged on a side surface of the lens frame.

9. An image pickup apparatus comprising the lens drive apparatus of claim 1.

10. A mobile terminal comprising the image pickup apparatus of claim 9.

11. A lens drive apparatus comprising:
an image pickup lens group;
a lens frame holding the image pickup lens group;
an actuator comprising a magnet, a yoke, and a coil formed of an electric conductor;
a casing housing the lens frame and the actuator therein; and
at least one guide shaft parallel to an optical axis of the image pickup lens group, the guide shaft being formed on the lens frame and fitted with the casing;
wherein an electromagnetic force generated when electricity is applied to the coil, moves the lens frame and the image pickup lens along the optical axis.

12. The lens drive apparatus of claim 11, comprising one guide shaft.

13. The lens drive apparatus of claim 11, comprising two guide shafts.

14. The lens drive apparatus of claim 11,
wherein the guide shaft comprises two ends arranged along different lines parallel to the optical axis and each fitted with the casing.

15. The lens drive apparatus of claim 11, further comprising:
a pressing member for pressing the lens frame in a predetermined direction,
wherein a part of the pressing member is engaged with or fixed to the lens frame.

16. The lens drive apparatus of claim 15,
wherein the pressing member is a plate spring.

17. The lens drive apparatus of claim 11,
wherein the coil, the magnet, and the yoke are arranged on a side surface of the lens frame.

18. An image pickup apparatus comprising the lens drive apparatus of claim 11.

19. A mobile terminal comprising the image pickup apparatus of claim 18.
